(19) United States
(12) Patent Application Publication
(10) Pub. No.: US 2020/0401134 A1
(43) Pub. Date: Dec. 24, 2020

(54) Autonomous Truck Unloading for Mining and Construction Applications

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/445,751

(22) Filed: Jun. 19, 2019

(51) Int. Cl. G05D 1/00; G05D 1/02

(52) U.S. Cl. CPC G05D 1/0088; G05D 1/0257; B60P 1/04; G05D 1/0287; G05D 1/0231

(57) ABSTRACT

Trucks in a mine or construction site move dirt, ore, or other matter from one location to another. The ore is usually loaded using an excavator or loader. Once at the unloading destination, the truck needs to determine where to unload the ore, dirt, or matter. Different applications require the load to be dumped in different manners. The present invention encodes this knowledge into a database of preferred behaviors and creates a set of automated maneuvers that accomplish these actions. The invention assumes that the truck has a drive-by-wire kit, and that its capable of moving under computer control. The present invention comprises a system to increase the safety of mining and construction autonomous trucks in which there are one or more sensors that can detect road features, a drive-by-wire kit installed on an autonomous truck, a planning algorithm that creates trajectories which take the autonomous vehicle from a starting location to a final location, while at the same time implementing randomizing the trajectory within the traversable road to minimize the ruts or purposely driving over the “high” points of the support surface to flatten the ruts or purposely avoiding (or stopping the vehicle) if a sharp object is detected on the route that can possibly puncture the tires or detecting debris that has been dropped from the truck, to alert other vehicles or itself when driven along the same route or detecting and historically tracking features in the road to determine road movement, and therefore alert to possible collapses or landslides or stopping the vehicle, or avoiding deep water puddles, detected by comparing the water surface and the pre-recorded support surface from a previous pass.

### CROSS REFERENCE TO RELATED PATENT APPLICATIONS

The present application claims priority from U.S. Patent Application Ser. No. 62/759,965, entitled “Autonomous Truck Unloading for Mining and Construction Applications”, filed on 12, Nov. 2018. The benefit under 35 USC § 119(e) of the United States provisional application is hereby claimed, and the aforementioned application is hereby incorporated herein by reference.

### STATEMENT REGARDING FEDERAL SPONSORSHIP

No part of this invention was a result of any federally sponsored research.

### TECHNICAL FIELD OF THE INVENTION

The present invention relates in general to autonomous systems, and, more specifically, to autonomous truck unloading for mining and construction applications.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A number of autonomous trucks are being developed for the mining and construction industries. Much of the automation is currently concentrated on the excavators, and on the autonomous driving of the trucks; however, as of now, not much automation exists for autonomously unloading the trucks.

Trucks in a mine or construction site move dirt, ore, or other matter from one location to another. The ore is usually loaded using an excavator or loader. Once at the unloading destination, the truck needs to determine where to unload the ore, dirt, or matter. Different applications require the load to be dumped in different manners. For example:

The load may be all dumped in one area, or it may be more desirable to dump it over larger areas to spread the load;

The truck may dump the load off the side of a hill;

The truck may want to fill a hole using the unloaded matter;

The truck may need to dump the load in a particular area, which is then automatically connected with a conveyor belt to another location;

The truck may only be allowed to dump in certain areas and not others;

The truck may want to dump in low areas of the terrain, in order to level the dumping area;

The truck may be approved to dump over water, or over areas that are wet.

These behaviors change significantly depending on the application, and also depending on the capabilities of the truck. For example, some trucks are capable of controlling their back gate, in order to control the spread of the load. Some trucks are side dumpers, while others are back or bottom dumpers. Procedures for organizing this process depend on the vehicle, application, and geography. This is because the area where the matter is being dropped, is usually being modified from one load to the next, posing challenges for automation. The invention proposed creates a set of automated behaviors that simplifies the process of shaping the dumping area. Maintaining these areas in an organized way increases the efficiency of the mine, as well as minimizes accidents and vehicle wear and tear.

For each of these applications, there are slightly different dumping techniques that are used by the truck driver. These particular techniques, and the problems associated with them, are learned with experience, and (to a certain degree) with some trial and error on the job. In order to automate the process, this knowledge needs to be explicitly encoded as part of the automation process.

The present invention encodes this knowledge into a database of preferred behaviors and creates a set of automated maneuvers that accomplish these actions. The invention assumes that the truck has a drive-by-wire kit, and that its capable of moving under computer control.

### BRIEF SUMMARY OF THE INVENTION

To minimize the limitations in the prior art, and to minimize other limitations that will be apparent upon reading and understanding the present specification, the present invention describes autonomous truck unloading for mining and construction applications.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an overview of autonomous truck unloading for mining and construction applications, as contemplated by the present disclosure;

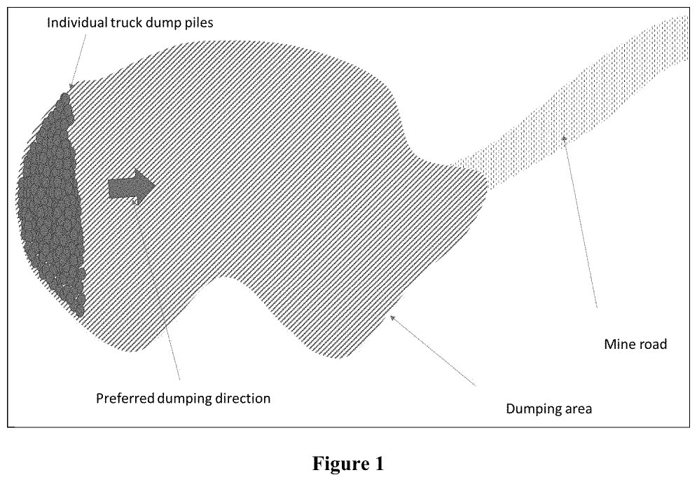

FIG. 2 illustrates an overview of autonomous truck unloading for mining and construction applications, as contemplated by the present disclosure; and

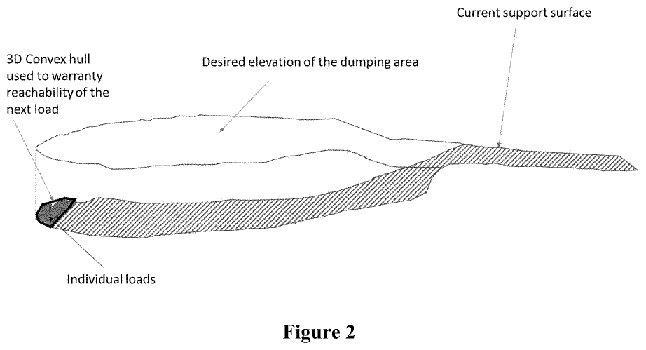

FIG. 3 illustrates an overview of autonomous truck unloading for mining and construction applications, as contemplated by the present disclosure.

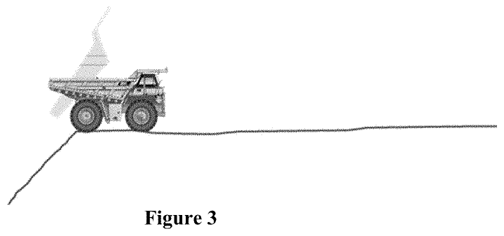

### DETAILED DESCRIPTION OF THE INVENTION

The system includes a variety of behaviors that can be customized for the particular mining or construction site. The behaviors are organized in a graphic scripting language that allows the mining/construction operator to assemble more complicated behaviors tailored for the particular site. The behaviors can be “recorded” by actually driving/teleoperating the truck, or they are prestored in a database.

In particular, the invention has the following behaviors already pre-programmed:

Dumping in an area. The operator will mark on the interface the dumping area with a polygon (or other marking mechanism, i.e. splines, or list of pixels). The operator will also specify the preferred order within the dumping area. For example, from north to south, etc. This behavior will automatically create routes for the autonomous truck, allowing it to position the dumping area adjacent to the previous dumped pile, while maintaining the directionality provided. Once the area has been finished, most operations use a grader to compact, and/or smooth the surface of the dumping area, before the next layer is added.

Dumping on a grade. Like the Dumping on an area, in this behavior, the operator defines an area to be dumped; then, rather than defining a particular preferred dumping direction, the operator defines a particular grade of the dumping area. The area does not need to be planar; it can be provided in a variety of 3D representation mechanisms. The invention then automatically finds the next dumping area, which will automatically get closer to the desired fill level, while not “locking the trucks in.” Planning for this can be accomplished in a variety of ways. In the preferred embodiment, we utilize a convex hull of previous piles, and only assigns destinations that are at the periphery of the growing hull, while warrantying achievability to the exposed surfaces of the hull. This warranties that that trucks will not get locked into situations where they cannot reach areas of the pile.

Dumping of a cliff. Under many scenarios, the mining operator may be interested in dumping the debris off a cliff. To undertake this operation, the operator will define the approximate cliff line and the invention will create a trajectory that will align the truck perpendicularly to the cliff line. It will then control the vehicle so as to expose the hopper off the border of the cliff, while maintaining a margin of safety. The autonomous system will use a LADAR, stereo pair, or other ranging sensor to find the edge of the cliff

Dumping along a line. Similar as with the “dumping in an area” behavior, in this case, the operator defines a line of sequences of lines. This behavior is used for shoring roads, or for making embankments, as well as to create water features. This behavior is also used for distributing dirt along the road to simplify the job of a grader. The operator can choose to determine the line, as well as the intervals at which he/she will prefer the piles to accumulate. The behavior allows the system to also determine partial loads, if the dumping mechanism allows for this process.

Dumping on a pile. The operator specifies the center of the pile, and the truck will automatically dump in the area of the pile that is closest to the center of the pile (provided by the operator) that is still reachable.

Coating a road or area. The operator identifies a road and an area, and the truck will gradually drop the load in the area, attempting to evenly distribute the load. The system will keep track of how much material has been dropped at each part of the assigned area, and automatically route trucks to dump in areas where the specified level of coating has not been achieved.

The scripting language allows the mine operators to assemble and compose new autonomous vehicle behavior. In this particular case, the behavior in question is the unloading of the autonomous truck.

The scripting language in the invention is a graphical user interface, where blocks in the display represent the elementary behavior upon which more complex behavior is built upon.

In particular, the scripting language has behavior blocks, sensing blocks, and logic blocks. Some of the blocks can be learned. For example, the operator may choose to record a trajectory. This trajectory becomes a behavior block. Now, the operator can link two or more of these behaviors to create a more complex behavior. For example, the 3 behaviors presented in the previous subsections are behavior blocks that can be scripted as part of a larger, more complex behavior. The sensor blocks allow the operator to concatenate behavior until a particular sensor (or combination of sensors) achieve a certain value.

For example, let's say that the mine operator would like to create a new unloading behavior. He/she can take a behavior block that encapsulates the motion of the truck to the unloading area, then use the behavior block “Dumping in area.” That behavior will generate a trajectory for the truck to the next needed load. Then, the operator can add a behavior to route from the dumping area to the beginning of the mine road or construction route. Finally, the operator can concatenate another behavior block that has the truck take the mine road or construction route back to the loading area. The scripting language in the invention is hierarchical, in the sense that more complex behaviors can be encapsulated by using simpler blocks. The preferred embodiment of the invention uses a visual language, as it is simpler to understand by the mining operators; however, other embodiments may have other scripting language that are not visual and use text to describe the sequences of actions.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims. Note with respect to the materials of construction, it is not desired nor intended to thereby unnecessarily limit the present invention by reason of such disclosure.

The present invention involves the development of a system to increase the safety of mining and construction autonomous trucks that comprise one ore more sensors that can detect road features, a drive-by-wire kit installed on an autonomous truck, a planning algorithm that creates trajectories which take the autonomous vehicle from a starting location to a final destination, while at the same time implementing randomizing the trajectory within the traversable road to minimize the ruts or purposely driving over the “high” points of the support surface to flatten the ruts or purposely avoiding (or stopping the vehicle) if a sharp object is detected on the route that can possibly puncture the tires or detecting debris that has been dropped from the truck, to alert other vehicles or itself when driven along the same route or detecting and historically tracking features in the road to determine road movement, and therefore alert to possible collapses or landslides or stopping the vehicle, or avoiding deep water puddles, detected by comparing the water surface and the pre-recorded support surface from a previous pass.

A drive-by-wire kit involves the use of electrical or electro-mechanical systems for performing vehicle functions traditionally achieved by mechanical linkages. This technology replaces the traditional mechanical control systems with electronic control systems using electromechanical actuators and human-machine interfaces such as pedal and steering feel emulators. Components such as the steering column, intermediate shafts, pumps, hoses, belts, coolers and vacuum servos and master cylinders are eliminated from the vehicle. This is similar to the fly-by-wire systems used widely in the aviation industry.

The system that has been developed has a perception module that uses a LADAR, a stereo pair, or a RADAR. LADAR stands for Laser Detection and Ranging and is a surveying method that measures distance to a target by illuminating the target with pulsed laser light and measuring the reflected pulses with a sensor. Differences in laser return times and wavelengths can then be used to make digital 3-D representations of the target. A stereo camera is type of camera with two or more lenses with a separate image sensor or film frame for each lens. This allows the camera to simulate human binocular vision, and therefore gives it the ability to capture three-dimensional images, a process known as stereo photography. RADAR is Radio Detection and Ranging and is a detection system that uses radio waves to determine the range, angle, or velocity of objects. It can be used to detect aircraft, ships, spacecraft, guided missiles, motor vehicles, weather formations, and terrain.

In this system, the features stored in the world model are shared by multiple vehicles. A road grader or operator is automatically summoned when the ruts become too large to traverse or is higher than a certain threshold. Also, a road grader or operator is automatically summoned if the water puddles are too deep to traverse, or deeper than a certain threshold. An operator is also summoned if the features on the road have moved above a certain threshold (which may indicate that the road could be prone to collapse or landslide). Also, an operator is summoned if a sharp object that can puncture the tires is found, even if it can be avoided by the A-kit.

An operator is also summoned if a certain threshold weight has been dropped from the truck. The system also contains a radio for transmitting road condition information to other systems equipped with the invention, or a centralized monitoring system. The raw sensors are on the vehicle, but some of the feature extraction and behavior generation algorithms are located outside of the truck.

The embodiments of the invention in which an exclusive property or privilege is claimed are defined as follows:

1. A system to increase the safety of mining and construction autonomous trucks, comprising:
one or more sensors that can detect road features;
a drive-by-wire kit installed on an autonomous truck;
a planning algorithm that creates trajectories which take the autonomous vehicle from a starting location to a final destination, while at the same time implementing randomizing the trajectory within the traversable road to minimize the ruts or purposely driving over the “high” points of the support surface to flatten the ruts or purposely avoiding (or stopping the vehicle) if a sharp object is detected on the route that can possibly puncture the tires or detecting debris that has been dropped from the truck, to alert other vehicles or itself when driven along the same route or detecting and historically tracking features in the road to determine road movement, and therefore alert to possible collapses or landslides or stopping the vehicle, or avoiding deep water puddles, detected by comparing the water surface and the pre-recorded support surface from a previous pass.

2. The system of claim 1 wherein the perception module uses a LADAR, or a stereo pair, or a RADAR.

3. The system of claim 1 or claim 2 wherein the features stored in the world model are shared by multiple vehicles.

4. The system of claims 1-3 wherein a road grader or operator is automatically summoned when the ruts become too large to traverse or goes above a certain threshold.

5. The system of claims 1-4 wherein a road grader or operator is automatically summoned if the water puddles are too deep to traverse, or deeper than a certain threshold.

6. The system of claims 1-5 wherein an operator is summoned if the features on the road have moved above a certain threshold (which may indicate that the road could be prone to collapse or landslide).

7. The system of claims 1-6 wherein an operator is summoned if a sharp object that can puncture the tires is found.

8. The system of claims 1-7 wherein an operator is summoned if a certain threshold weight has been dropped from the truck.

9. The system of claims 1-8, further comprising a radio for transmitting road condition information to other systems equipped with the invention, or a centralized monitoring system.

10. The system of claims 1-9 wherein the raw sensors are on the vehicle, but some of the feature extraction and behavior generation algorithms are located outside of the truck.
